(19) United States
(12) Patent Application Publication
(10) Pub. No.: US 2014/0094230 A1
(43) Pub. Date: Apr. 3, 2014

(54) PORTABLE COMMUNICATION APPARATUS AND ANTENNA SWITCHING METHOD

(71) Applicant: FUJITSU LIMITED, Kawasaki-shi (JP)

(72) Inventors: Kouji SOEKAWA, Kawasaki (JP); Shinya TACHIBANA, Kawasaki (JP)

(73) Assignee: FUJITSU LIMITED, Kawasaki-shi (JP)

(21) Appl. No.: 13/974,698

(22) Filed: Aug. 23, 2013

(30) Foreign Application Priority Data
Oct. 3, 2012 (JP) 2012-221392

(51) Int. Cl. H01Q 5/00

(52) U.S. Cl. CPC H01Q 5/0031
USPC 455/575.7

(57) ABSTRACT

There is provided a portable communication apparatus which includes a main antenna including a first element and a second element to be capable of being resonant at a first and a third frequencies, respectively, the third frequency being one between the first frequency and a second frequency higher than the first frequency, a switch provided between the main antenna and a high-frequency circuit, a capacitor disposed in parallel to the switch, the capacitor being connected between the main antenna and the high-frequency circuit, and a control circuit configured to control the switch to turn on and off such that when the switch is in an ON state, the first element is resonant at the first frequency, while when the switch is in an OFF state, the main antenna is coupled to the high-frequency circuit via the capacitor, and the second element is resonant at the second frequency.

### CROSS-REFERENCE TO RELATED APPLICATION

This application is based upon and claims the benefit of priority from the prior Japanese Patent Application No. 2012-221392 filed on Oct. 3, 2012, the entire contents of which are incorporated herein by reference.

### FIELD

The embodiments discussed herein are related to a portable communication apparatus and an antenna switching method.

### BACKGROUND

In recent years, a portable telephone service according to a high-speed data communication standard called long term evolution (LTE (registered trademark)) has been started. To receive the LTE service, a portable telephone apparatus may be configured using a multiple input multiple output (MIMO) technique and may include a sub-antenna for use in downlink communication in addition to a main antenna.

Frequencies used in the LTE service have been expanded from a single 2 GHz band to a multiband including, for example, an 880 MHz band, a 1.5 GHz band, and the like. As a result, portable telephone apparatuses are supposed to have a multiantenna to adapt to a plurality of frequency bands.

However, a tendency toward a reduction in total size of the portable telephone apparatus results in a reduction in an internal space thereof. Thus, it is desired to install an antenna apparatus in a limited space. To this end, it is desirable to achieve a reduction in the size of the antenna apparatus.

Descriptions of related techniques may be found, for example, in International Publication Pamphlet No. WO 2009/019782, Japanese Laid-open Patent Publication No. 2009-224945, Japanese Registered Utility Model No. 3104150, Japanese Laid-open Patent Publication No. 2012-23493, Japanese Laid-open Patent Publication No. 10-98405, and Japanese Laid-open Patent Publication No. 2012-60380.

### SUMMARY

According to an aspect of the invention, a portable communication apparatus includes a main antenna part including a first element configured to be capable of being resonant at a first frequency and a second element configured to be capable of being resonant at a third frequency, the third frequency being one between the first frequency and a second frequency higher than the first frequency, a switch provided between the main antenna part and a high-frequency circuit, a capacitor disposed in parallel to the switch, the capacitor being connected between the main antenna part and the high-frequency circuit, and a control circuit configured to control the switch to turn on and off such that when the switch is in an ON state, the first element is resonant at the first frequency, while when the switch is in an OFF state, the main antenna part is coupled to the high-frequency circuit via the capacitor, and the second element is resonant at the second frequency.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of an external appearance of an antenna apparatus according to an embodiment.

FIG. 2 is a schematic diagram illustrating an example of a main antenna part according to an embodiment.

FIG. 3 is a schematic diagram illustrating an example of an antenna apparatus according to an embodiment.

FIG. 4 is a diagram illustrating an example of an antenna radiation characteristic of an antenna apparatus according to an embodiment.

FIG. 5A is a diagram illustrating an example of a VSWR characteristic of an antenna apparatus in a situation in which a switch is in an ON state according to an embodiment.

FIG. 5B is a diagram illustrating an example of a VSWR characteristic of an antenna apparatus in a situation in which a switch is in an OFF state according to an embodiment.

FIG. 6 is a schematic diagram illustrating an example of a main antenna part according to an embodiment.

FIG. 7 is a diagram illustrating an example of an antenna radiation characteristic of an antenna apparatus according to an embodiment.

FIG. 8A is a diagram illustrating an example of a VSWR characteristic of an antenna apparatus in a situation in which a switch is in an ON state according to an embodiment.

FIG. 8B is a diagram illustrating an example of a VSWR characteristic of an antenna apparatus in a situation in which a switch is in an OFF state according to an embodiment.

FIG. 9 is a schematic diagram illustrating an example of a main antenna part according to an embodiment.

FIG. 10 is a diagram illustrating an example of an antenna radiation characteristic of an antenna apparatus according to an embodiment.

FIG. 11A is a diagram illustrating an example of a VSWR characteristic of an antenna apparatus in a situation in which a switch is in an ON state according to an embodiment.

FIG. 11B is a diagram illustrating an example of a VSWR characteristic of an antenna apparatus in a situation in which a switch is in an OFF state according to an embodiment.

FIG. 12 is a schematic diagram illustrating an example of a main antenna part according to an embodiment.

FIG. 13 is a schematic diagram illustrating an example of an antenna apparatus according to an embodiment.

FIG. 14 is a diagram illustrating an example of an antenna radiation characteristic of an antenna apparatus according to an embodiment.

FIG. 15A is a diagram illustrating an example of a VSWR characteristic of an antenna apparatus in a situation in which a switch is in an ON state according to an embodiment.

FIG. 15B is a diagram illustrating an example of a VSWR characteristic of an antenna apparatus in a situation in which a switch is in an OFF state according to an embodiment.

### DESCRIPTION OF EMBODIMENTS

### Preliminary Considerations

In an antenna apparatus for use in a portable telephone apparatus, for example, a frequency of 1.5 GHz is nearly twice a frequency of 880 MHz. This may cause antenna elements to have currents of opposite phases. As a result, for example, a current flowing in an 880 MHz band element may cancel out a current flowing in a 1.5 GHz element. This makes it difficult for the 1.5 GHz element to have a sufficient current, and thus a reduction in antenna performance may occur.

It is known to configure the antenna apparatus of the portable telephone apparatus such that a single element is shared by a plurality of frequency bands using a matching circuit. For example, the single element is configured to have an antenna length resonant in the 880 MHz band. When this element is used in the 1.5 GHz band, a capacitor with a small capacitance is used to achieve matching in the 1.5 GHz band. However, in this antenna apparatus, when the capacitor with the small capacitance is used to achieve the resonance at 1.5 GHz, the capacitor has a high impedance at 1.5 GHz, which makes it difficult for the element to have a sufficient current in the 1.5 GHz band. As a result, a reduction in antenna performance occurs.

In view of the above, embodiments are disclosed herein as to a portable communication apparatus and an antenna switching method preferable to provide a high antenna performance.

Embodiments of a portable communication apparatus and an antenna switching method are described in detail below with reference to drawings. Note that embodiments described below are only for illustration but not limitation. Note that embodiments described below may be combined as long as no conflicts occur.

### FIRST EMBODIMENT

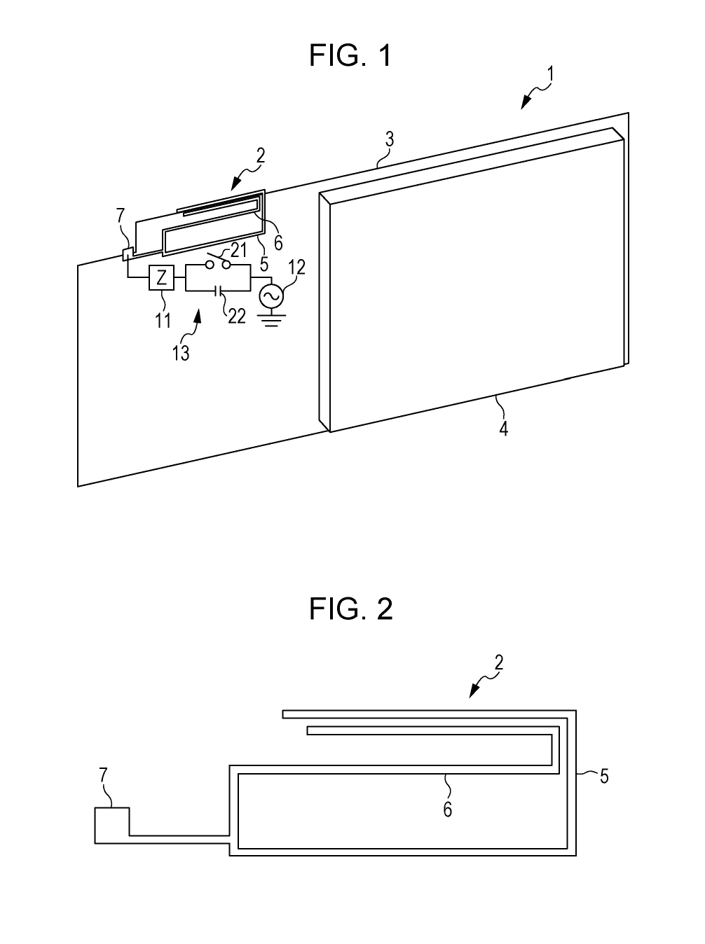

FIG. 1 is a schematic diagram illustrating an example of an external appearance of an antenna apparatus 1 according to an embodiment. The antenna apparatus 1 illustrated in FIG. 1 may be, for example, an antenna apparatus of a portable telephone apparatus. The antenna apparatus 1 includes a main antenna part 2, a circuit board 3, and a battery unit 4. The main antenna part 2 is configured in the form of a two-element monopole antenna split at a feeding point 7 into a first element 5 and a second element 6.

The first element 5 is an antenna element with a resonance characteristic set to be resonant in a first frequency band, for example, a 880 MHz band centered about 880 MHz. The second element 6 is an antenna element with a resonance characteristic set to be resonant in a third frequency band between the first frequency band and a second frequency band. For example, the second frequency band may be a 1.5 GHz band and the third frequency band may be a 1.1 GHz band centered about 1.1 GHz.

FIG. 2 is a schematic diagram illustrating an example of the main antenna part 2 according to the first embodiment. As described above, the main antenna part 2 illustrated in FIG. 2 is split at the feeding point 7 into the first element 5 and the second element 6. The first element 5 is configured to be resonant in the 880 MHz band, and thus the first element 5 has a greater antenna length than that of the second element 6. In contrast, the second element 6 is configured to be resonant in the 1.1 GHz band, and thus the second element 6 has a smaller antenna length than that of the first element 5.

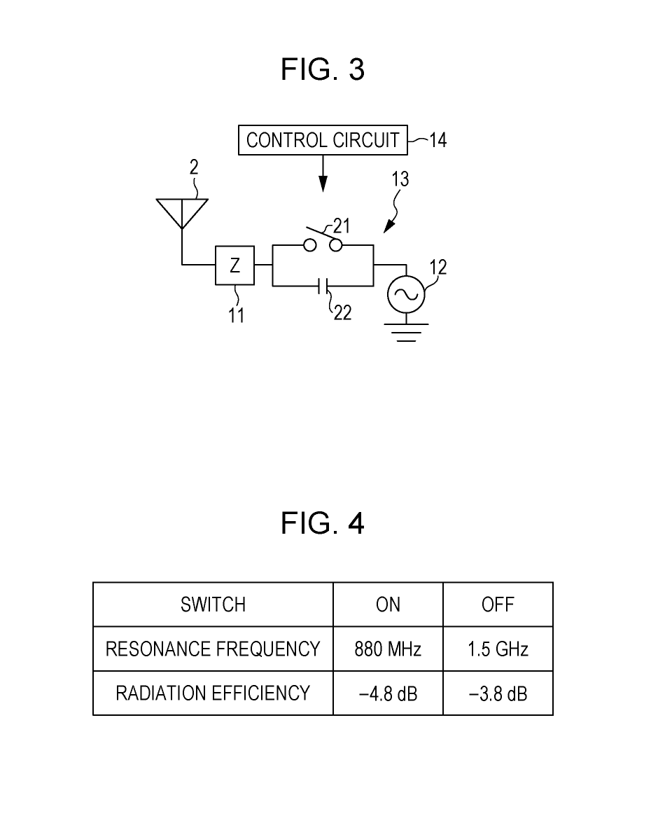

FIG. 3 is a schematic diagram illustrating an example of the antenna apparatus 1 according to the first embodiment. In the example illustrated in FIG. 3, the antenna apparatus 1 includes the main antenna part 2, a matching circuit 11, a high-frequency circuit 12, a parallel circuit 13, and a control circuit 14. The high-frequency circuit 12 is a circuit configured to provide high-frequency power to the main antenna part 2. The parallel circuit 13 includes a switch 21 connected between the main antenna part 2 and the high-frequency circuit 12, and a capacitor 22 connected in parallel with the switch 21 and between the main antenna part 2 and the high-frequency circuit 12. The capacitor 22 functions to match the resonance frequency of the second element 6, for example, at 1.1 GHz to 1.5 GHz. For example, in a case where matching at 1.1 GHz to 1.5 GHz is achieved when the capacitor 22 has capacitance of 0.75 pF, the capacitor 22 has an impedance of about 140 Ω at 1.5 GHz, which allows a current to easily flow into the second element 6 at 1.5 GHz. The control circuit 14 controls the switch 21 in the parallel circuit 13 to turn on or off.

Because the resonance frequency of the first element 5 is set to 880 MHz, and the resonance frequency of the second element 6 is set to 1.1 GHz, the first element 5 and the second element 6 have similar characteristics in terms of the resonance frequency and a current distribution. As a result, for example, currents of opposite phases flowing in the first element 5 and the second element 6 are reduced, which makes it possible for a current to easily flow into the second element 6.

Next, the operation of the antenna apparatus 1 according to the first embodiment is described. FIG. 4 is a diagram illustrating an example of an antenna radiation characteristic of the antenna apparatus 1 according to the first embodiment. When the control circuit 14 turns the switch 21 in the parallel circuit 13 into an ON state or a connected state, the main antenna part 2 is directly connected to the high-frequency circuit 12. In this state, the first element 5 operates as a radiating element resonant in the 880 MHz band. In this state, as illustrated in FIG. 4, the first element 5 has a radiation efficiency of −4.8 dB. The target value of the radiation efficiency of the first element 5 in the 880 MHz band is −5 dB, and thus the target value is achieved.

On the other hand, when the control circuit 14 turns the switch 21 in the parallel circuit 13 into an OFF state or a disconnected state, the main antenna part 2 is coupled to the high-frequency circuit 12 not directly but via the capacitor 22. The intervention of the capacitor 22 causes the matching of the resonance frequency of the second element 6 to be shifted from the 1.1 GHz band to the 1.5 GHz band, and thus the second element 6 operates as a radiating element resonant in the 1.5 GHz band. In this state, as illustrated in FIG. 4, the second element 6 has a radiation efficiency of −3.8 dB. The target value of the radiation efficiency of the second element 6 in the 1.5 GHz band is −4 dB, and thus the target value is achieved.

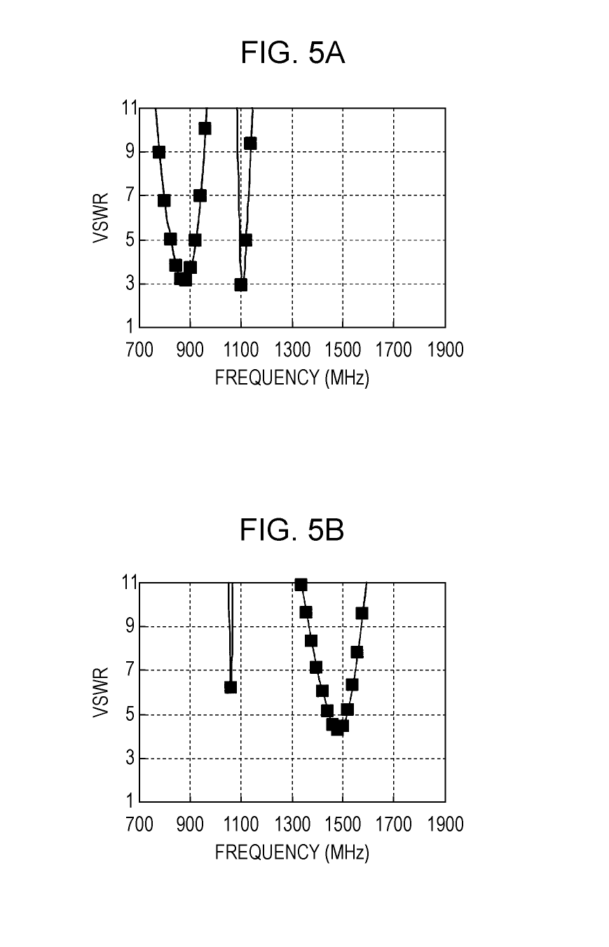

FIG. 5A illustrates an example of a voltage standing wave ratio (VSWR) characteristic of the antenna apparatus 1 according to the first embodiment when the switch is in the ON state. In FIG. 5A, the first element 5 has a VSWR value of about 3 at frequencies near 880 MHz. On the other hand, the second element 6 has a VSWR value of about 3 at frequencies near 1.1 GHz. Note that the VSWR value is an index indicating the antenna performance, and the smaller the VSWR, the higher the antenna performance.

FIG. 5B illustrates an example of a VSWR characteristic of the antenna apparatus 1 according to the first embodiment when the switch is in the OFF state. In FIG. 5B, the first element 5 has a VSWR value of about 6 at frequencies near 1 GHz. On the other hand, the second element 6 has a VSWR value of about 4 at frequencies near 1.5 GHz.

That is, in the antenna apparatus 1, the first element 5 operates as the radiating element resonant in the 880 MHz band when the switch 21 is in the ON state, while when the switch 21 is in the OFF state, the second element 6 operates as the radiating element resonant in the 1.5 GHz band.

In the antenna apparatus 1 according to the first embodiment, the resonance frequency of the second element 6 is set to 1.1 GHz between 880 MHz and 1.5 GHz. When the switch 21 turns off, the intervening of the capacitor 22 causes the second element 6 to be resonant at 1.5 GHz. Thus, in this configuration, because the resonance frequencies of the first element 5 and the second element 6 are close to each other, no opposite phases occur in currents, which allows a current to easily flow into the second element 6. Therefore, a high antenna performance is achieved.

In the antenna apparatus 1, only a small change in matching occurs when the resonant frequency of the second element 6 shifts from 1.1 GHz to 1.5 GHz, and thus the capacitor 22 may not have a very small capacitance. For example, 0.75 pF may be sufficient as the capacitance of the capacitor 22. Thus, the impedance of the capacitor 22 at 1.5 GHz is as low as about 140 Ω, which allows a current to easily flow into the second element 6. Therefore, a high antenna performance is achieved.

In the antenna apparatus 1 according to the first embodiment, the first element 5 and the second element 6 are formed such that end portions of these two elements are spaced apart from each other by a small distance. However, the layout of the first element 5 and the second element 6 is not limited to the example described above. For example, the layout of the second element 6 may be changed such that the space between the end portion of the first element 5 and the end portion of the second element 6 is expanded. This configuration is discussed in detail in a second embodiment described below. In the following description of the second embodiment, similar elements or parts to those in the antenna apparatus 1 according to the first embodiment are denoted by similar reference symbols, and a further description of such elements or parts and a description of operations thereof are omitted.

### SECOND EMBODIMENT

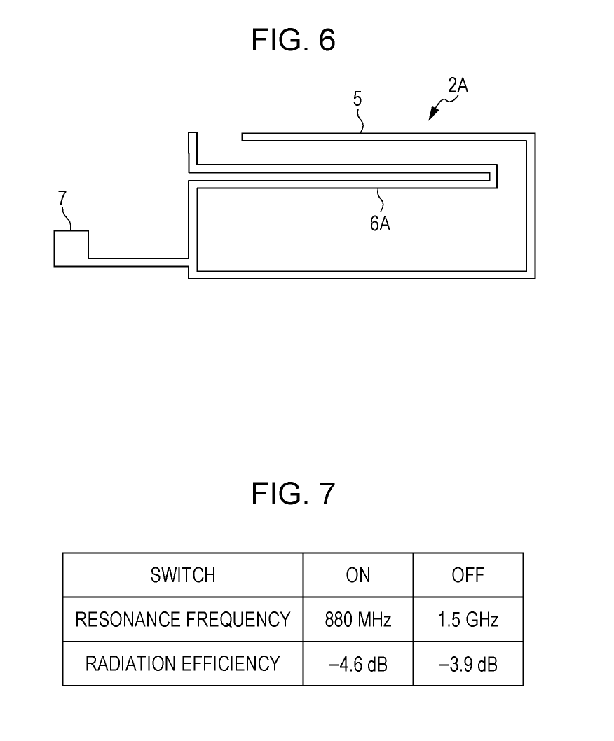

FIG. 6 is a schematic diagram illustrating an example of a main antenna part 2A according to the second embodiment. In the main antenna part 2A illustrated in FIG. 6, the manner of extending the second element 6A is changed such that the space between the end portion of the first element 5 and the end portion of the second element 6A is increased, which results in a reduction in capacitive coupling of electromagnetic induction between the first element 5 and the second element 6A.

FIG. 7 is a diagram illustrating an example of an antenna radiation characteristic of the antenna apparatus 1 according to the second embodiment. When the control circuit 14 turns on the switch 21 in the parallel circuit 13, the main antenna part 2A is directly connected to the high-frequency circuit 12. In this state, the first element 5 operates as a radiating element resonant in the 880 MHz band. In this state, as illustrated in FIG. 7, the first element 5 has a radiation efficiency of −4.6 dB.

On the other hand, when the control circuit 14 turns off the switch 21 in the parallel circuit 13, the main antenna part 2A is coupled to the high-frequency circuit 12 not directly but via the capacitor 22. The provision of the capacitor 22 causes the matching of the resonance frequency of the second element 6A to be shifted from 1.3 GHz band to the 1.5 GHz band, and thus the second element 6A operates as a radiating element resonant in the 1.5 GHz band. In this state, as illustrated in FIG. 7, the second element 6A has a radiation efficiency of −3.9 dB.

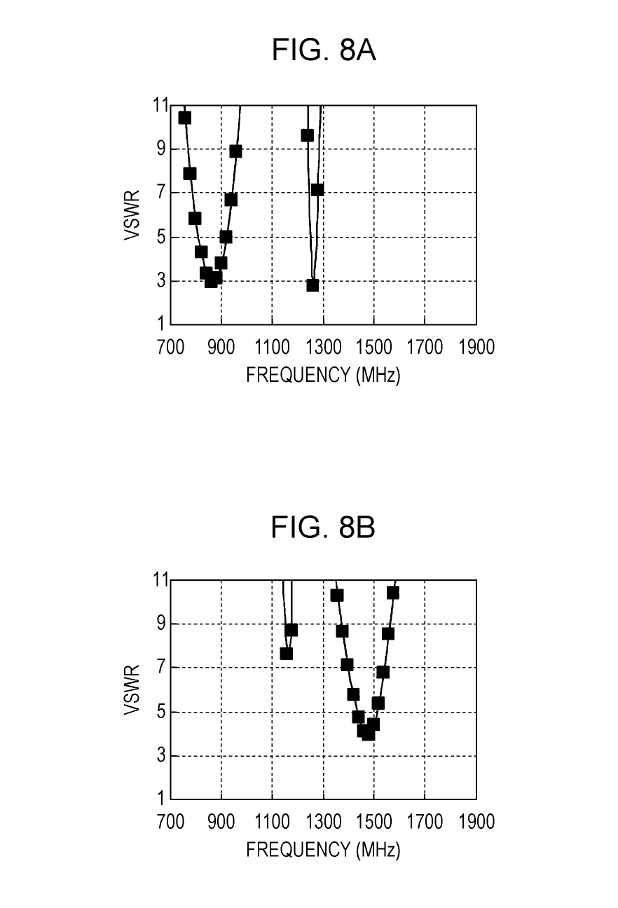

FIG. 8A illustrates an example of a VSWR characteristic of the antenna apparatus 1 according to the second embodiment when the switch is in the ON state or the . In FIG. 8A, the first element 5 has a VSWR value of about 3 at frequencies near 880 MHz. On the other hand, the second element 6A has a VSWR value of about 3 at frequencies near 1.3 GHz.

FIG. 8B illustrates an example of a VSWR characteristic of the antenna apparatus 1 according to the second embodiment when the switch is in the OFF state. In FIG. 8B, the first element 5 has a VSWR value of about 7 at frequencies near 1.1 GHz. On the other hand, the second element 6A has a VSWR value of about 4 at frequencies near 1.5 GHz.

As described above, in the antenna apparatus 1 according to the second embodiment, the space between the end portion of the first element 5 and the end portion of the second element 6A is increased so as to reduce the capacitive coupling between the first element 5 and the second element 6A. Also in this configuration, it is ensured to obtain an antenna performance similar to that achieved in the first embodiment.

In the antenna apparatus 1 according to the first embodiment, the first element 5 is formed in a linear line shape. Alternatively, the first element 5 may be formed in a meander shape. This configuration is discussed in detail in a third embodiment described below. In the following description of the third embodiment, similar elements or parts to those in the antenna apparatus 1 according to the first embodiment are denoted by similar reference symbols, and a further description of such elements or parts and a description of operations thereof are omitted.

### THIRD EMBODIMENT

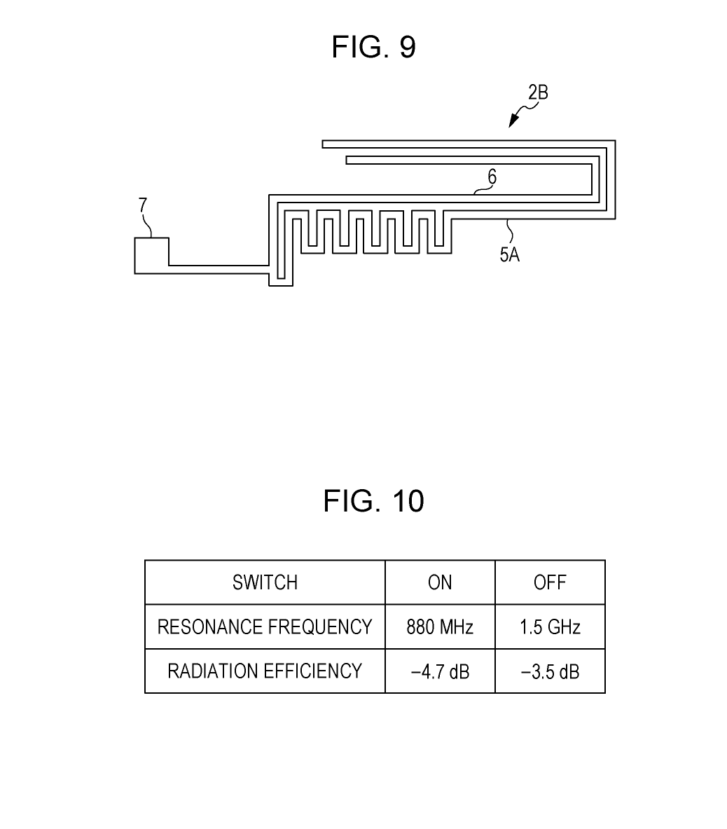

FIG. 9 is a schematic diagram illustrating an example of a main antenna part 2B according to the third embodiment. In the main antenna part 2B illustrated in FIG. 9, the first element 5A includes a portion formed in a meander shape, and the first element 5A and the second element 6 are disposed so as to be closely adjacent to each other such that capacitive coupling between the first element 5A and the second element 6 is increased.

FIG. 10 is a diagram illustrating an example of an antenna radiation characteristic of the antenna apparatus 1 according to the third embodiment. When the control circuit 14 turns on the switch 21 in the parallel circuit 13, the main antenna part 2B is directly connected to the high-frequency circuit 12. In this state, the first element 5A operates as a radiating element resonant in the 880 MHz band. In this state, as illustrated in FIG. 10, the first element 5A has a radiation efficiency of −4.7 dB.

On the other hand, when the control circuit 14 turns off the switch 21 in the parallel circuit 13, the main antenna part 2B is coupled to the high-frequency circuit 12 not directly but via the capacitor 22. The provision of the capacitor 22 causes the matching of the resonance frequency of the second element 6 to be shifted from 1.2 GHz band to the 1.5 GHz band, and thus the second element 6 operates as a radiating element resonant in the 1.5 GHz band. In this state, as illustrated in FIG. 10, the second element 6 has a radiation efficiency of −3.5 dB.

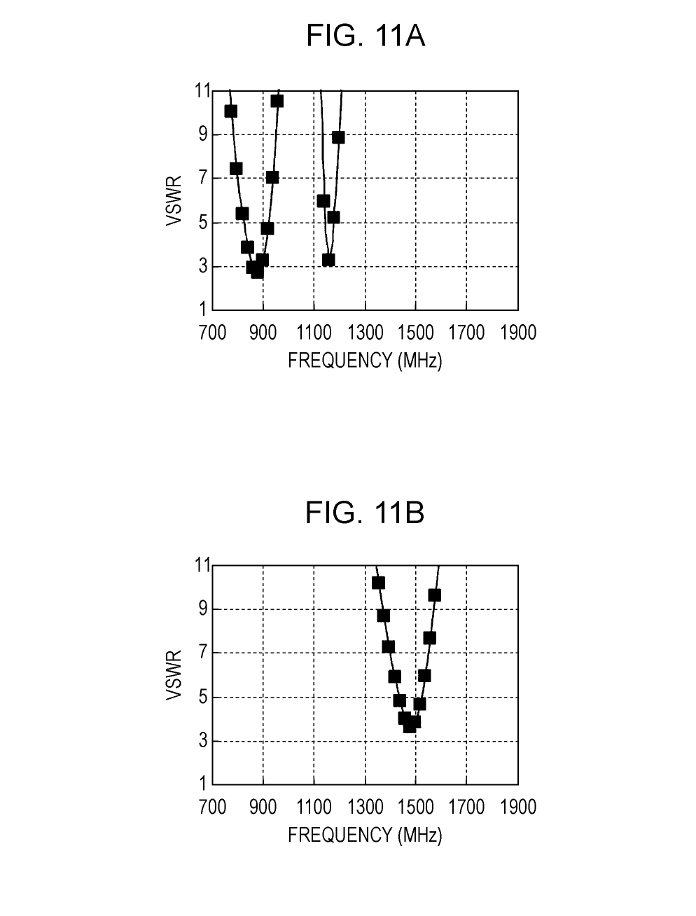

FIG. 11A illustrates an example of a VSWR characteristic of the antenna apparatus 1 according to the third embodiment when the switch is in the ON state. In FIG. 11A, the first element 5A has a VSWR value of about 3 at frequencies near 880 MHz. On the other hand, the second element 6 has a VSWR value of about 3 at frequencies near 1.2 GHz.

FIG. 11B illustrates an example of a VSWR characteristic of the antenna apparatus 1 according to the third embodiment when the switch is in the OFF state. In FIG. 11B, the second element 6 has a VSWR value of about 4 at frequencies near 1.5 GHz.

As described above, in the antenna apparatus 1 according to the third embodiment, the first element 5A includes the portion of the meander shape, and the capacitive coupling between the first element 5A and the second element 6 is increased. This makes it possible to reduce the size of the antenna apparatus 1 while maintaining a high antenna performance similar to that achieved by the first embodiment.

In the antenna apparatus 1 according to the third embodiment, the first element 5A is formed in the meander shape as described above. Alternatively, the first element 5A may be formed in a linear line shape, and an inductor may be provided to compensate for a reduction in the antenna length resulting from the change of the shape first element 5A into the linear line shape so as to maintain the resonance frequency. This configuration is discussed in detail in a fourth embodiment described below. In the following description of the fourth embodiment, similar elements or parts to those in the antenna apparatus according to the first embodiment are denoted by similar reference symbols, and a further description of such elements or parts and a description of operations thereof are omitted.

### FOURTH EMBODIMENT

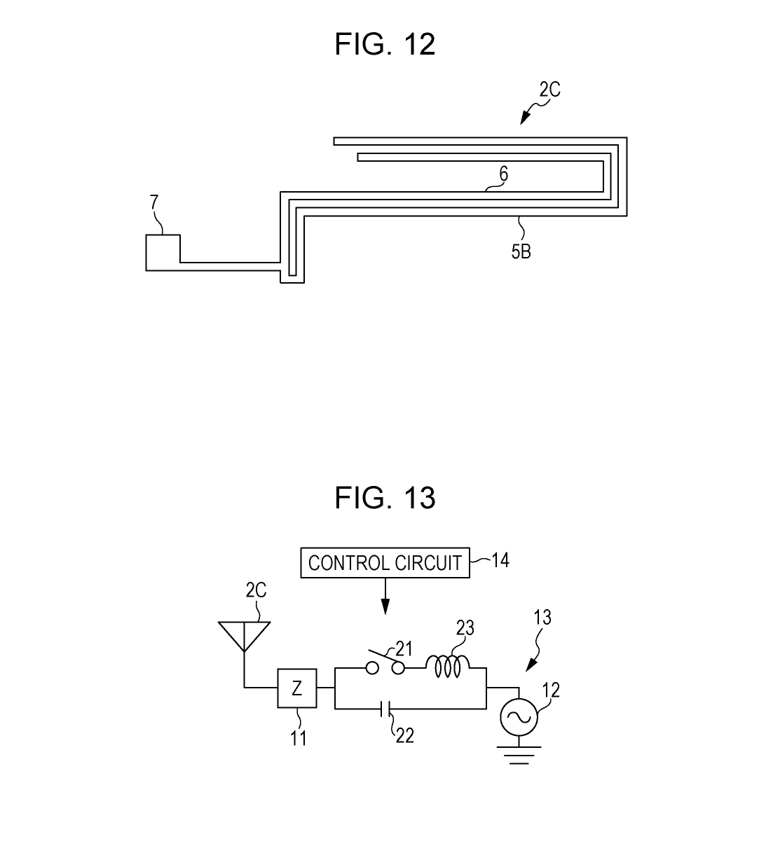

FIG. 12 is a schematic diagram illustrating an example of a main antenna part 2C according to the fourth embodiment. As illustrated in FIG. 12, the main antenna part 2C is formed such that the first element 5B and the second element 6 are disposed so as to be adjacent to each other. An inductor 23 is provided to compensate for the reduction in the antenna length of the first element 5B such that the first element 5B is resonant at 880 MHz.

FIG. 13 is a schematic diagram illustrating an example of the antenna apparatus 1 according to the fourth embodiment. The antenna apparatus 1 illustrated in FIG. 13 includes the main antenna part 2C, a high-frequency circuit 12, a parallel circuit 13, and a control circuit 14. The parallel circuit 13 includes a switch 21 and an inductor 23 connected in series between the main antenna part 2C and the high-frequency circuit 12, and a capacitor 22 connected between the main antenna part 2C and the high-frequency circuit 12. The provision of the inductor 23 causes the resonance frequency of the first element 5B to decrease to 880 MHz. When the capacitor 22 has a capacitance of, for example, 0.75 pF, the inductance of the inductor 23 may be set to, for example, 3.3 nH.

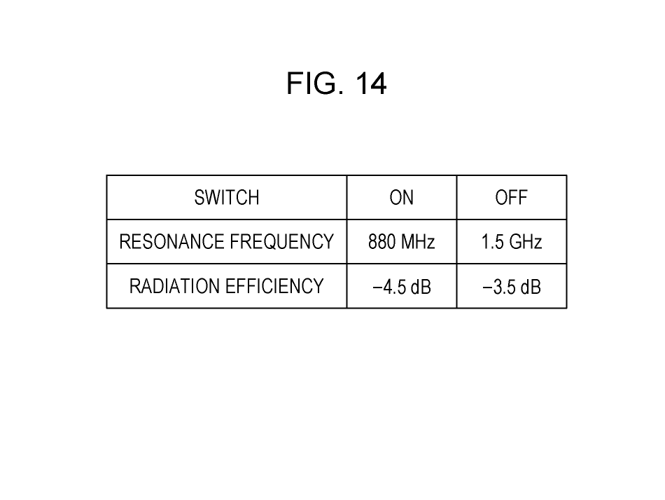

FIG. 14 is a diagram illustrating an example of an antenna radiation characteristic of the antenna apparatus 1 according to the fourth embodiment. When the control circuit 14 turns on the switch 21 in the parallel circuit 13, the main antenna part 2C is coupled to the high-frequency circuit 12 via the inductor 23. The provision of the inductor 23 reduces the resonance frequency by an amount corresponding to an increase in resonance frequency caused by the reduction in antenna length of the first element 5B such that the first element 5B operates as a radiating element resonant in the 880 MHz band. In this state, as illustrated in FIG. 14, the first element 5B has a radiation efficiency of −4.5 dB.

On the other hand, when the control circuit 14 turns off the switch 21 in the parallel circuit 13, the main antenna part 2C is coupled to the high-frequency circuit 12 via only the capacitor 22. The provision of the capacitor 22 causes the matching of the resonance frequency of the second element 6 to be shifted from 1.3 GHz band to the 1.5 GHz band, and thus the second element 6 operates as a radiating element resonant in the 1.5 GHz band. In this state, as illustrated in FIG. 14, the second element 6 has a radiation efficiency of −3.5 dB.

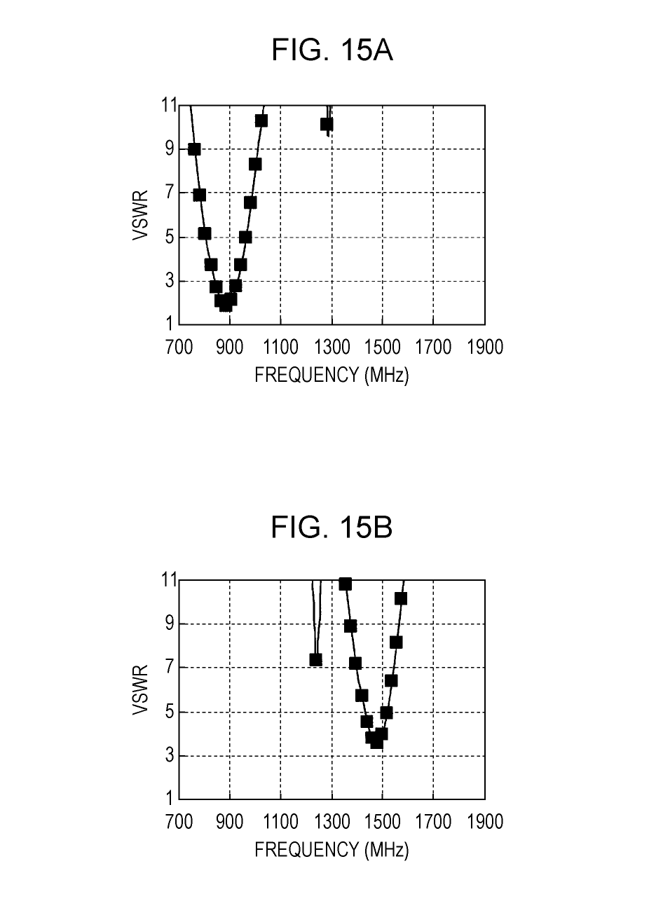

FIG. 15A illustrates an example of a VSWR characteristic of the antenna apparatus 1 according to the fourth embodiment when the switch is in the ON state. In FIG. 15A, the first element 5B has a VSWR value of about 3 at frequencies near 880 MHz. On the other hand, the second element 6 has a VSWR value of about 10 at frequencies near 1.3 GHz.

FIG. 15B illustrates an example of a VSWR characteristic of the antenna apparatus 1 according to the fourth embodiment when the switch is in the OFF state. In FIG. 15B, the first element 5B has a VSWR value of about 7 at frequencies near 1.25 GHz. On the other hand, the second element 6 has a VSWR value of about 3 at frequencies near 1.5 GHz.

As described above, in the antenna apparatus 1 according to the fourth embodiment, the antenna length of the first element 5B is reduced, and the inductor 23 is provided to compensate for the change in resonance frequency of the first element 5B. Also in this configuration, it is ensured to obtain an antenna performance similar to that achieved in the first embodiment. Furthermore, the reduction in the antenna length of the first element 5B allows a reduction in the total size of the antenna apparatus 1.

In the embodiments described above, the second element 6 is configured such that the resonance frequency thereof is in a range from 880 MHz to 1.5 GHz, and more particularly, for example, from 1.1 GHz to 1.3 GHz. However, the values are not limited to those in the examples described above.

In the embodiments described above, the first frequency is 880 MHz, and the second frequency is 1.5 GHz. However, these values are given only as examples, and the values are not limited to those in the examples.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A portable communication apparatus comprising:
a main antenna part including a first element configured to be capable of being resonant at a first frequency and a second element configured to be capable of being resonant at a third frequency, the third frequency being one between the first frequency and a second frequency higher than the first frequency;
a switch provided between the main antenna part and a high-frequency circuit;
a capacitor disposed in parallel to the switch, the capacitor being connected between the main antenna part and the high-frequency circuit; and
a control circuit configured to control the switch to turn on and off such that when the switch is in an ON state, the first element is resonant at the first frequency, while when the switch is in an OFF state, the main antenna part is coupled to the high-frequency circuit via the capacitor, and the second element is resonant at the second frequency.

2. The portable communication apparatus according to claim 1, wherein an inductor is connected in series to the switch such that a series connected of the inductor of the switch is connected between the main antenna part and the high-frequency circuit.

3. The portable communication apparatus according to claim 1, wherein
an antenna length of the first element is corresponding to a resonance characteristic at the first frequency, and
an antenna length of the second element is corresponding to a resonance characteristic at the third frequency.

4. An antenna switching method for use in a portable communication apparatus, the antenna switching method comprising:
resonating a first element at a first frequency according to turn on a switch to connect a main antenna part with a high-frequency circuit, wherein the portable communication apparatus includes the main antenna part which includes the first element configured to be capable of being resonant at the first frequency and a second element configured to be capable of being resonant at a third frequency between the first frequency and a second frequency higher than the first frequency, the switch, and a capacitor disposed in parallel to the switch and connected between the main antenna part and the high-frequency circuit; and
turning off the switch such that the second element is resonant at the second frequency.
